(19) United States
(12) Patent Application Publication
(10) Pub. No.: US 2025/0316937 A1
(43) Pub. Date: Oct. 9, 2025

(54) ELECTRICAL MODULE WITH HERMAPHRODITIC CONNECTION ARRANGEMENT

(71) Applicant: Group Dekko, Inc., Fort Wayne, IN (US)

(72) Inventor: Brian K. Rupert, Kendallville, IN (US)

(73) Assignee: Group Dekko, Inc., Fort Wayne, IN (US)

(21) Appl. No.: 18/630,385

(22) Filed: Apr. 9, 2024

(51) Int. Cl. H01R 24/84; A47B 21/06; E04B 2/74; H01R 25/00; H02G 3/38

(52) U.S. Cl. CPC H01R 24/84; A47B 21/06; E04B 2/7401; H01R 25/006; A47B 2021/066; E04B 2002/7488; H02G 3/388

(57) ABSTRACT

An electrified office furniture system includes: at least one piece of office furniture; and an electrical distribution system associated with the at least one piece of office furniture, the electrical distribution system including: a first electrical module which is a first electrical receptacle or a first jumper assembly, the first electrical module including a first electrical connection arrangement that is hermaphroditic; and a second electrical module which is a second electrical receptacle or a second jumper assembly, the second electrical module including a second electrical connection arrangement that is hermaphroditic, the first electrical module and the second electrical module being selectively and releasably connected directly to one another by way of the first electrical connection arrangement and the second electrical connection arrangement.

### BACKGROUND OF THE INVENTION

### 1. Field of the Invention

The present invention relates to electrified furniture systems, and, more particularly, to electrical modules of the electrified furniture systems.

### 2. Description of the Related Art

Furniture includes office furniture, such as wall panels (such as modular wall panels), tables, benches, desks, shelves, or the like. At least certain types of office furniture can be associated with electrical distribution systems, so as to carry electricity to desired locations.

Modular wall panels have been used for a number of years to divide a relatively large open space into smaller cubicles or workspaces and have the advantage of being comparatively easily rearranged. Electrification of those wall panels was one of the early improvements. Many techniques for power or communications wiring in modular furniture are known. Wall panels and other modular components may have raceways for enclosing the wiring which may be installed on site as the panels are being assembled, or which may be factory installed to be later interconnected by panel-to-panel interconnects or jumpers. The electrification of such wall panels may thus be accomplished by an electrical distribution system.

Generally, such an electrical distribution system may include multiple channel electrical distribution harnesses (which can also be referred to as an electrical distribution harness assembly or an electrical distribution harness), electrical cables, e.g. jumper cables (which can also be referred to as jumper devices, jumper assemblies, or jumpers), which interconnect the electrical distribution harnesses together, and electrical receptacles. Each electrical distribution harness may mount multiple inlet connection points for receiving the jumpers and electrical receptacle connection points for receiving the electrical receptacles. Each electrical distribution harness may distribute electrical power from the jumpers to the electrical receptacles. The electrical distribution system is typically mounted internally within a structure, such as a wall (such as the aforementioned modular wall panels) or a series of desks.

The wall panels, for instance, that accommodate the electrical distribution system must be wide enough to accommodate the electrical distribution system. The width of such wall panels are already minimized. Thus, a problem arises when a thinner wall panel is desired, such as a one-inch thick wall panel.

What is needed in the art is an electrical distribution system that has a relatively thin profile.

### SUMMARY OF THE INVENTION

The present invention provides an electrical distribution system including (i) a first electrical module which is a first electrical receptacle or a first jumper assembly and (ii) a second electrical module which is a second electrical receptacle or a second jumper assembly, the first electrical module and the second electrical module being selectively and releasably connected directly to one another using hermaphroditic electrical connection arrangements of each of the first and second electrical modules.

The invention in one form is directed to an electrified office furniture system includes: at least one piece of office furniture; and an electrical distribution system associated with the at least one piece of office furniture, the electrical distribution system including: a first electrical module which is a first electrical receptacle or a first jumper assembly, the first electrical module including a first electrical connection arrangement that is hermaphroditic; and a second electrical module which is a second electrical receptacle or a second jumper assembly, the second electrical module including a second electrical connection arrangement that is hermaphroditic, the first electrical module and the second electrical module being selectively and releasably connected directly to one another by way of the first electrical connection arrangement and the second electrical connection arrangement.

The invention in another form is directed to an electrical distribution system for an electrified office furniture system, the electrified office furniture system including at least one piece of office furniture, the electrical distribution system being associated with the at least one piece of office furniture, the electrical distribution system including: a first electrical module, the first electrical module being a first electrical receptacle or a first jumper assembly, the first electrical module including a first electrical connection arrangement that is hermaphroditic, the first electrical module being configured for being selectively and releasably connected directly to a second electrical module-which is a second electrical receptacle or a second jumper assembly and includes a second electrical connection arrangement that is hermaphroditic—by way of the first electrical connection arrangement and the second electrical connection arrangement.

The invention in yet another form is directed to a method of using an electrified office furniture system, the method including the steps of: providing that the electrified office furniture system includes at least one piece of office furniture and an electrical distribution system associated with the at least one piece of office furniture, the electrical distribution system including a first electrical module and a second electrical module, the first electrical module being a first electrical receptacle or a first jumper assembly and including a first electrical connection arrangement that is hermaphroditic, the second electrical module being a second electrical receptacle or a second jumper assembly and including a second electrical connection arrangement that is hermaphroditic; and connecting, selectively and releasably, the first electrical module and the second electrical module directly to one another by way of the first electrical connection arrangement and the second electrical connection arrangement.

An advantage of the present invention is that it provides an electrical distribution system that does not require an electrical distribution module (such as an electrical distribution harness or a splitter block) or any other spacer device (which has one or more electrical connectors) to which electrical receptacles and jumper assemblies are attached, though the electrical distribution system can optionally include such an electrical distribution module. As a result, the electrical distribution system can be used within a piece of office furniture that is relatively thin, such as one-inch thick (for example and not limitation, a one-inch thick raceway of a modular wall panel).

Another advantage of the present invention is that it provides that electrical receptacles and jumper assemblies can be connected directly to one another.

Yet another advantage of the present invention is that it provides electrical receptacles and jumpers which have hermaphroditic electrical connectors, which can mate relative to one another.

Yet another advantage of the present invention is that the electrified office furniture system can include various types of pieces of office furniture, such as wall panels (such as modular wall panels), tables, benches, desks, shelves, or the like.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of an electrified office furniture system including a wall panel and an electrical distribution system, according to an exemplary embodiment of the present invention;

FIG. 2 is a perspective view of the electrical distribution system of FIG. 1, according to an exemplary embodiment of the present invention;

FIG. 3 is an exploded perspective view of the electrical distribution system of FIG. 2, according to an exemplary embodiment of the present invention;

FIG. 4 is an exploded side view of the electrical distribution system of FIG. 2, with portions broken away, according to an exemplary embodiment of the present invention;

FIG. 5 is an exploded perspective view of an electrical terminal of the electrical distribution system of FIG. 2, according to an exemplary embodiment of the present invention;

FIG. 6 is an exploded perspective view of a jumper assembly of the electrical distribution system of FIG. 2, according to an exemplary embodiment of the present invention;

FIG. 7 is a perspective view of the electrical distribution system of FIG. 2, according to an exemplary embodiment of the present invention;

FIG. 8 is an end view of a jumper assembly of the electrical distribution system of FIG. 2, according to an exemplary embodiment of the present invention;

FIG. 9 is a side view of receptacles of the electrical distribution system in a second orientation, according to an exemplary embodiment of the present invention; and

FIG. 10 is a flow diagram showing a method of using the electrified office furniture system, in accordance with an exemplary embodiment of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

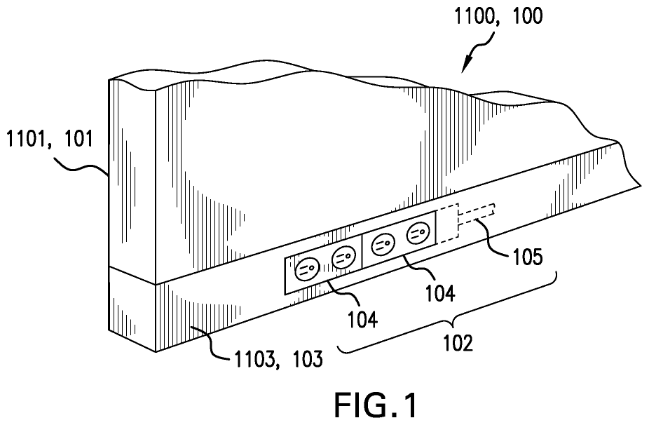

Referring now to the drawings, and more particular to FIG. 1, there is shown an electrified office furniture system 1100, which includes at least one piece of office furniture 1101 and an electrical distribution system 102 associated with the at least one piece of office furniture 1101. The reference number 1100 generally refers to an electrical distribution system of various embodiments, and the reference number 1101 generally refers to a piece of office furniture of various embodiments. Thus, office furniture 1101 generally refers to any sort of office furniture, which can be used to make a space suitable for working, though such office furniture 1101 need not be in an office but can be located in any location employing electricity. For example (and not limitation), office furniture 1101 can be, for example (and not limitation), wall panels (such as modular wall panels 101), tables, benches, desks, cabinets, shelves, raceways (though not part of a wall panel), or the like. Office furniture 1101, in FIG. 1, is shown according to one exemplary embodiment of the present invention to be a modular wall panel 101; thus, electrified office furniture system 1100, in FIG. 1, is shown according to one exemplary embodiment of the present invention to be an electrified wall panel system 100. Though electrified office furniture system 1100 is shown to be an electrified wall panel system 100 according to one embodiment of the present invention, electrified office furniture system 1100 is not limited to being an electrified wall panel system 100, as indicated by the notion that office furniture 1101 can be not only wall panel 101 but other types of office furniture 1101, as indicated above. Further, electrical distribution system 102 is associated with office furniture 1101 in any suitable manner. For instance, electrical distribution system 102 can be positioned on or in (in whole or in part) office furniture 1101 and can be coupled with office furniture 1101 in any suitable manner. For example, the at least one piece of office furniture 1101 can include an elongate distribution arrangement 1103 (the reference number 1103 generally refers to an elongate distribution arrangement of various embodiments), the electrical distribution system 102 being associated with elongate distribution arrangement 1103 and optionally being coupled with elongate distribution arrangement 1103. Thus, in the embodiment shown and described herein, office furniture 1101 is shown as modular wall panel 101, which can be a plurality of modular wall panels 101 which are placed in an end-to-end fashion relative to each other in an office or other commercial or home office setting. Each wall panel 101 generally includes elongate distribution arrangement 103 in the form a raceway 103 that is an elongate hollow opening extending across the width of panel 101 at a convenient location, which line up with each other in an end-to-end manner from panel 101 to panel 101. For example, as indicated, raceways 103 could be formed as a number of beltline raceways which line up with each other in an end-to-end manner from panel to panel, or could be raceways 103 formed at or near the bottom of panels 101 which line up with each other in an end-to-end manner from panel to panel. As another example, as indicated, the office furniture 1101 could be a desk or a table, and the elongate distribution arrangement 1103 could be a distribution channel formed in the desk or table. As yet another example, the elongate distribution arrangement 1103 could be in the form of an elongate channel with a generally U-shaped cross section which is attached to the bottom of the desk or table. Thus, each said elongate distribution arrangement 1103 can, for example and not limitation, include: a beltline raceway in an office wall panel; a bottom raceway 103 in an office wall panel 101; a distribution channel formed in a desk or table; or a distribution channel attached to the bottom of a desk or table.

FIG. 1 thus shows panel system 100, which can, according to an exemplary embodiment of the present invention, be a modular wall panel system used in an office space to partition an open floor plan environment by way of partitioning walls. Panel system 100 includes wall panel 101 (for example, a modular wall panel used as such a partitioning wall) and an electrical distribution system 102 coupled in any suitable manner with wall panel 101. Wall panel 101 includes a raceway 103, electrical distribution system 102 being coupled with, or otherwise associated with, raceway 103. Wall panel 101 is relatively thin (and thus also raceway 103), such as one-inch thick. Wall panel 101 can be a wall of any height and/or distance from the ceiling; for example, wall panel 101 may extend from floor to ceiling, or at any intermediate height therebetween. Further, depending upon the height of wall panel 101, raceway 103 may be positioned at any height within wall panel, for example, at the bottom of wall panel 101 (as in FIG. 1), at the top of wall panel 101, or at a beltline of wall panel 101. Further, wall panel 101 may alternatively be positioned at any select height above the floor and at any select distance from the ceiling.

Electrical distribution system 102 can be at least partially positioned within raceway 103 and can include electrical power distribution elements and/or data distribution elements. Electrical distribution system 102, in FIG. 1, is shown to include two electrical receptacles 104 (shown schematically and connected to one another mechanically and electrically) and a jumper assembly 105 (which can also be referred to as a jumper or a jumper device, is shown schematically, and is shown in broken lines because jumper 105 is placed in raceway 103). Here, receptacles 104 can be entirely positioned within raceway 103, or can be partially enclosed within raceway 103, and can partially extend outside of raceway 103. Receptacles 104 are coupled with, or otherwise associated with, and at least partially enclosed within raceway 103, and jumper 105 is coupled with, or otherwise associated with, and at least partially enclosed within raceway 103. The combination of elements 104, 105 shown in FIG. 1 are shown merely by way of example and not limitation. Other combinations can be used instead, for example, a single receptacle 104, or receptacles 104 facing in opposite directions rather than in the same direction as shown in FIG. 1, or jumpers 105 connected to one another. Electrical distribution system 102 can be any suitable system; by way of example and not limitation, electrical distribution system 102 can be a two circuit, four wire system.

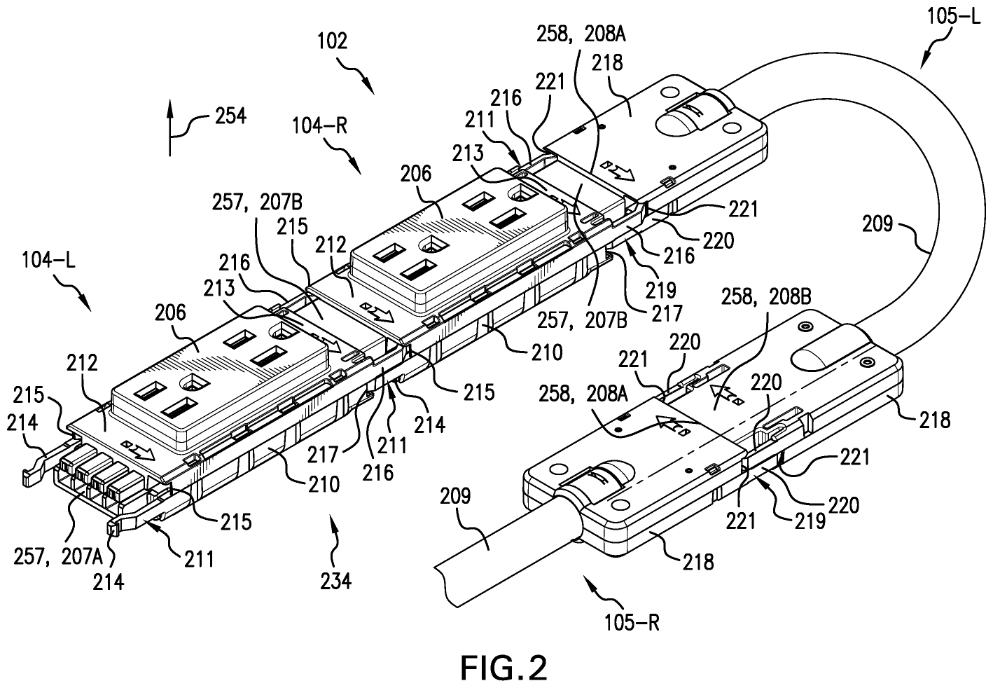

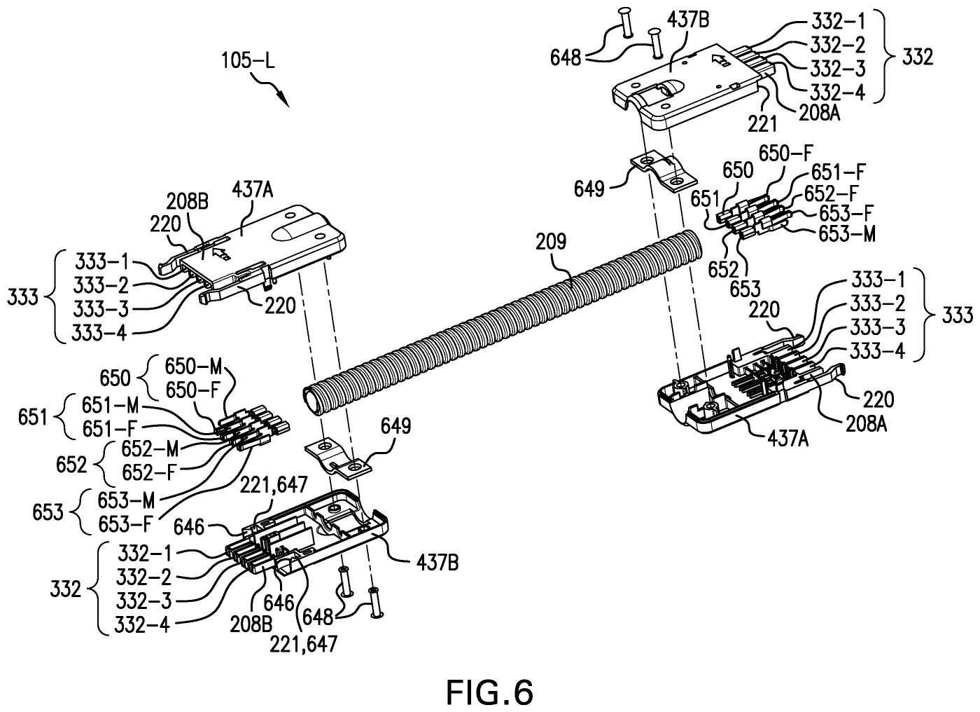

Referring now to FIG. 2, there is shown a perspective view of an embodiment of electrical distribution system 102, which is consistent with what is shown in FIG. 1, according to an exemplary embodiment of the present invention. System 102 includes two receptacles 104-L, 104-R joined directly to one another, jumper assembly 105-L connected directly to receptacle 104-R, and another jumper assembly 105-R connected directly to jumper assembly 105-L. Proceeding from left to right in FIG. 2, receptacle 104-L is the left receptacle, 104-R is the right receptacle, jumper 105-L is the left jumper assembly, and jumper 105-R is the right jumper assembly. Receptacles 104-L, 104-R are substantially identical to one another. Receptacle 104-L is the same as the left receptacle 104 in FIG. 1, receptacle 104-R is the same as the right receptacle 104 in FIG. 1, and jumper 105-L is the same as jumper 105 in FIG. 1. Receptacles 104-L, 104-R and jumpers 105-L, 105-R each are electrical modules. Each receptacle 104-L, 104-R includes an outlet face 206, to which a three-pronged electrical plug can be directly connected. Here, outlet faces 206 of receptacles 104-L, 104-R are shown to point in the same direction. However, alternatively, receptacles 104-L, 104-R can be directly connected to one another in such a way that outlet faces 206 point in opposite directions relative to one another (which is explained further below). As shown in FIG. 2, receptacles 104-L, 104-R can directly connect with one another; thus, an electrical distribution harness is not required as an intermediate device by which to couple electrical receptacles together (indirectly). Similarly, jumpers 105-L, 105-R can directly connect with one another; thus, an electrical distribution harness is not required as an intermediate device by which to couple jumper assemblies together (indirectly). Similarly, receptacles 104-L, 104-R can directly connect with one another; thus, an electrical distribution harness is not required as an intermediate device by which to couple electrical receptacles and jumper assemblies together (indirectly). Jumpers 105-L, 105-R are shown to include conduit 209, which are shown schematically in FIGS. 2, 3, and 4 but which are shown in FIG. 6, according to an exemplary embodiment of conduit 209, to have a round flexible body; according to an alternative embodiment of the jumper assembly, the jumper assembly can include a conduit that has a flexible mesh body that has a generally flat cross-section, such that the jumper assembly is a mesh jumper.

Each receptacle 104-L, 104-R includes an electrical connection arrangement 257, that includes electrical connectors 207A, 207B at opposing ends 212, 213 of respective receptacles 104-L, 104-R. Respective electrical connectors 207A, 207B of receptacles 104-L, 104-R are shown in FIG. 2 to be connected directly to one another, and electrical connector 207B of receptacle 104-R is connected to an electrical connector 208A of jumper 105-L. Electrical connection arrangement 257 is hermaphroditic, and thus electrical connectors 207A, 207B are hermaphroditic; electrical connectors 207A, 207B are substantially identical to one another. Thus, electrical connectors 207A, 207B can be selectively directly connected with other electrical connectors 207A, 207B. Each jumper 105-L, 105-R includes an electrical connection arrangement 258, that includes electrical connectors 208A, 208B at opposing ends of respective jumpers 105-L, 105-R (according to an exemplary embodiment of jumper 105-R, jumper 105-R is substantially identical to jumper 105-L, though alternatively jumper 105-R may omit a body 218 and an electrical connector 208B on the end of conduit 209 that is broken away and thus not visible in FIG. 2). Respective electrical connectors 208A, 208B of jumpers 105-L, 105-R are shown in FIG. 2 to be connected directly to electrical connector 207B of receptacle 104-R and electrical connector 208A of jumper 105-R. Electrical connection arrangement 258 is hermaphroditic, and thus electrical connectors 208A, 208B are hermaphroditic; electrical connectors 208A, 208B are substantially identical to one another. Thus, electrical connectors 208A, 208B can selectively directly connect with other electrical connectors 208A, 208B. Further, electrical connectors 207A, 207B can selectively directly connect with other electrical connectors 207A, 207B, electrical connectors 208A, 208B can selectively directly connect with other electrical connectors 208A, 208B, and electrical connectors 207A, 207B and 208A, 208B can selectively directly connect with one another. Further, jumpers 105-L, 105-R each includes conduit 209 joining electrical connectors 208A, 208B.

Further, each receptacle 104-L, 104-R includes a body 210, a first end 212, a second end 213 opposing first end 212, and a latching arrangement 211. Body 210 at least partly includes electrical connectors 207A, 207B, which include ports 330, 331 defined by body 210 and respective longitudinal ends of electrical terminals 540, 541, 542, 543 housed within body 210. Further, each jumper 105-L, 105-R includes a body 218 and a latching arrangement 219. Body 218 at least partly includes electrical connectors 208A, 208B, each of which includes ports 332, 333 defined by body 218 and respective longitudinal ends of electrical terminals 650, 651, 652, 653 housed within body 218. First end 212 of receptacles 104-L, 104-R includes electrical connector 207A, and second end 213 of receptacles 104-L, 104-R includes electrical connector 207B. The left end of jumpers 105-L, 105-R includes electrical connector 208A, and the right end of jumpers 105-L, 105-R includes electrical connector 208B.

Latching arrangement 211 of receptacle 104-L, 104-R includes a first pair of male latch members 214, a first pair of female latch members 215, a second pair of male latch members 216, a second pair of female latch members 217, first end 212 including the first pair of male latch members 214 and the first pair of female latch members 215, second end 213 including the second pair of male latch members 216 and the second pair of female latch members 217. According to an embodiment of the present invention, male latch members 214, 216 are substantially similar to one another, and female latch members 215, 217 are substantially similar to one another. Body 210 of each receptacle 104-L, 104-R defines female latch members 215, 217. Latching arrangement 211 is configured for releasably securing receptacles 104-L, 104-R with one another. As shown in FIG. 2, the second pair of female latch members 217 of second end 213 of receptacle 104-L and the second pair of male latch members 216 of second end 213 of receptacle 104-L are selectively and releasably coupled with the first pair of male latch members 214 of first end 212 of receptacle 104-R and the first pair of female latch members 215 of first end 212 of receptacle 104-R respectively. Female latch members 215, 217 receive male latches latch members 214, 216 and releasably latch thereto (as explained further below).

Latching arrangement 211 of receptacle 104-L, 104-R includes a first pair of male latch members 214, a first pair of female latch members 215, a second pair of male latch members 216, a second pair of female latch members 217, first end 212 including the first pair of male latch members 214 and the first pair of female latch members 215, second end 213 including the second pair of male latch members 216 and the second pair of female latch members 217. Latching arrangement 219 of jumpers 105-L, 105-R includes a pair of male latch members 220 and a pair of female latch members 221. According to an embodiment of the present invention, male latch members 214, 216, 220 are substantially similar to one another, and female latch members 215, 217, 221 are substantially similar to one another. Body 210 of each receptacle 104-L, 104-R defines female latch members 215, 217, and each body 218 of jumpers 105-L, 105-R defines female latch members 221.

Latching arrangements 211, 219 are configured for releasably securing receptacles 104-L, 104-R with one another, receptacles 104-R and jumpers 105-L with one another, and jumpers 105-L, 105-R with one another. As shown in FIG. 2, the second pair of female latch members 217 of second end 213 of receptacle 104-L and the second pair of male latch members 216 of second end 213 of receptacle 104-L are selectively and releasably coupled with the first pair of male latch members 214 of first end 212 of receptacle 104-R and the first pair of female latch members 215 of first end 212 of receptacle 104-R respectively. Further, the second pair of male latch members 216 of second end 213 of receptacle 104-R and the second pair of female latch members 217 of second end 213 of receptacle 104-R are selectively and releasably coupled with the pair of female latch members 221 of the left end of jumper 105-L and the pair of male latch members 220 of the left end of jumper 105-L respectively. Further, the pair of male latch members 220 of the opposing right end of jumper 105-L and the pair of female latch members 221 the opposing right end of jumper 105-L are selectively and releasably coupled with the pair of female latch members 221 of one end of jumper 105-R and the pair of male latch members 220 of one end of jumper 105-R respectively. Female latch members 215, 217, 221 receive male latches latch members 214, 216, 220 and releasably latch thereto (as explained further below).

Further, though not shown, according to an alternative embodiment of the present invention, body 210 of receptacles 104-L, 104-R can include screw tabs on longitudinally extending sides of receptacles 104-L, 104-R. Fasteners, such as screws, can be inserted through holes in such screw tabs so as to secure (directly or indirectly) receptacles 104-L, 104-R to a respective wall panel 101, for example.

Further, receptacles 104-L, 104-R are selectively and releasably connected directly to one another in one of two orientations 234, 935 and are configured for being selectively and releasably connected directly to one another in the other of the two orientations 234, 935 (which can also be referred to as first orientation 234 and second orientation 935). That is, user is able to connect receptacles 104-L in orientation 234 or, alternatively in orientation 935, according to the needs of the installation situation. In this way, an electrical distribution harness is not required to electrify receptacles 104-L, 104-R and to mount electrical receptacles 104-L, 104-R in or otherwise to raceway 103; instead, electrical receptacles 104-L, 104-R can be mounted directly to one another, in either of two orientations 234, 935. FIG. 2 shows electrical receptacles 104-L, 104-R in orientation 234. Thus, when receptacles 104-L, 104-R are in orientation 234 (as shown in FIG. 2), outlet face 206 of receptacle 104-L and outlet face 206 of receptacle 104-R each face in the same direction, that is, in first direction 254, and electrical connector 207B of receptacle 104-L is connected directly to electrical connector 207A of receptacle 104-R.

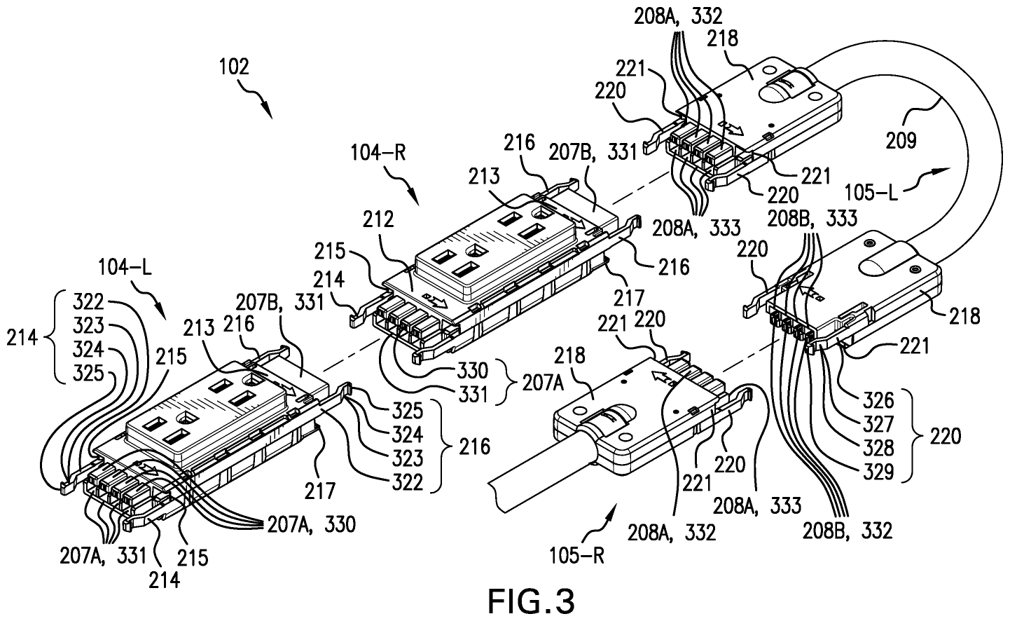

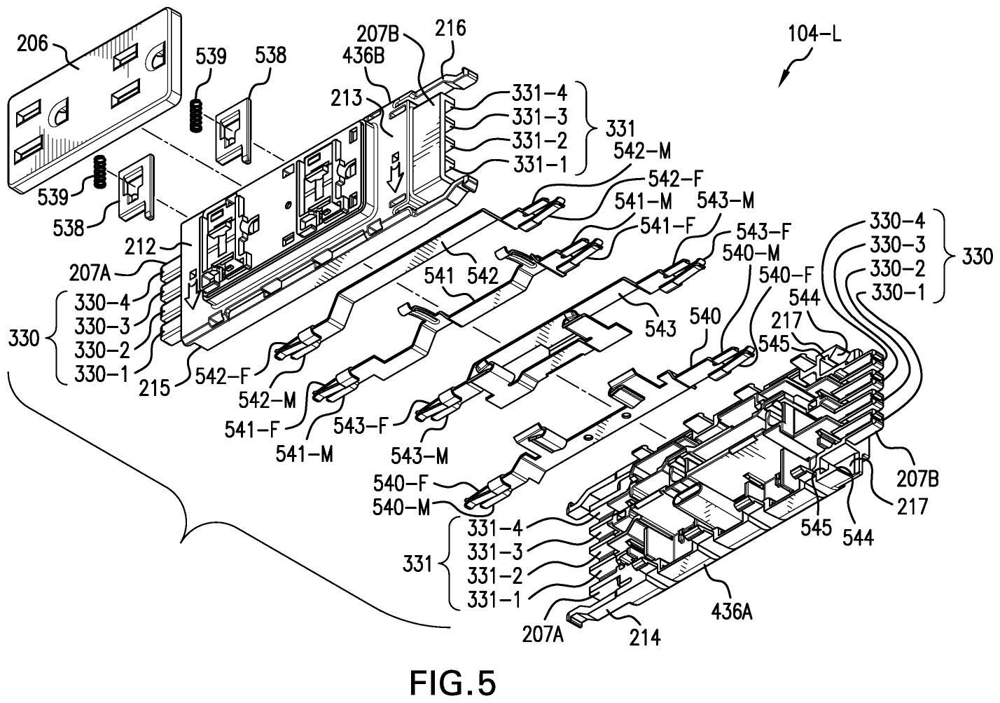

Referring now to FIG. 3, there is shown an exploded perspective view of electrical distribution system 102 shown in FIG. 2. Each electrical connector 207A, 207B includes male ports 330 and female ports 331. Male ports 330 accommodate or otherwise include therein female portions 540-F, 541-F, 542-F, 543-F of electrical terminals 540, 541, 542, 543, and female ports 331 include therein male portions 540-M, 541-M, 542-M, 543-M of electrical terminals 540, 541, 542, 543 (see FIG. 5). Female ports 331 of either of electrical connectors 207A, 207B matingly receive therein male ports 330 of the other of electrical connectors 207A, 207B. Similarly, each electrical connector 208A, 208B includes male ports 332 and female ports 333, which are substantially similar to male ports 330 and female ports 331, respectively. Male ports 332 accommodate or otherwise include therein female portions 650-F, 651-F, 652-F, 653-F of electrical terminals 650, 651, 652, 653, and female ports 333 include therein male portions 650-M, 651-M, 652-M, 653-M of electrical terminals 650, 651, 652, 653 (see FIG. 6). Female ports 333 of either of electrical connectors 208A, 208B matingly receive therein male ports 332 of the other of electrical connectors 207A, 207B. Further, male ports 330 and female ports 331 of receptacles 104-L, 104-R are substantially similar to male ports 330 and female ports 331, respectively, of jumpers 105-L, 105-R; thus, female ports 331 can matingly receive therein male ports 333, and female ports 333 can receive therein male ports 330.

Further, each male latch member 214, 216 of receptacles 104-L, 104-R includes a proximal portion 322 and a distal portion 323, proximal portion 322 extending from body 210 as a cantilevered beam 322, distal portion 323 extending from proximal portion 322 as a hook 324, which includes a barb 325. Similarly, each male latch member 220 of jumpers 105-L, 105-R includes a proximal portion 326 and a distal portion 327, proximal portion 326 extending from body 218 as a cantilevered beam 326, distal portion 327 extending from proximal portion 326 as a hook 328, which includes a barb 329.

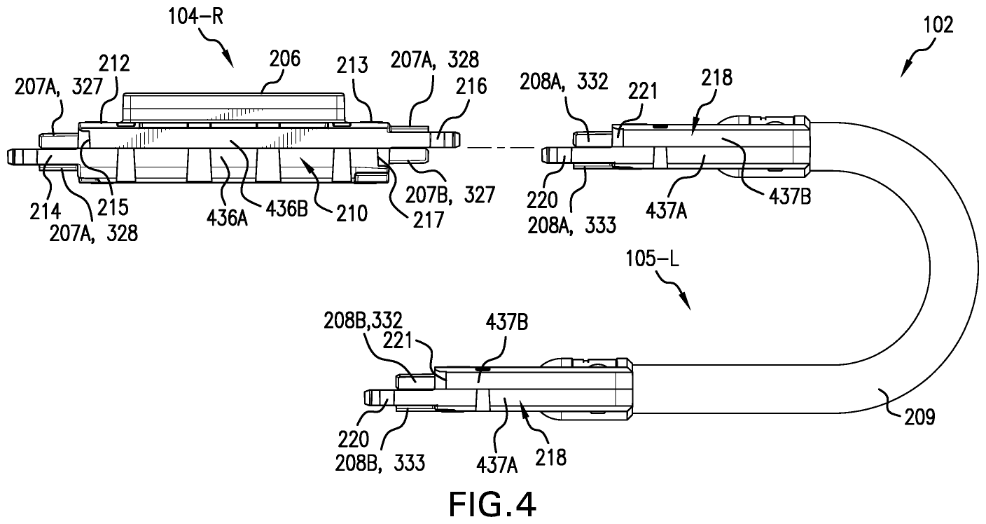

Referring now to FIG. 4, there is shown an exploded side view of electrical distribution system 102, with portions broken away. More specifically, FIG. 4 shows receptacle 104-R and jumper 105-L detached from one another. Regarding receptacle 104-R (and thus also receptacle 104-L), on first end 212 the pair of female latch members 215 are vertically displaced relative to the pair of male latch members 214 such that the pair of female latch members 215 are positioned above the pair of male latch members 214, and on second end 213 the pair of female latch members 217 are vertically displaced relative to the pair of male latch members 216 such that the pair of female latch members 217 are positioned vertically below the pair of male latch members 216. Similarly, regarding jumper 105-L (and thus also jumper 105-R), with respect to body 218 on the left end of jumper 105-L in FIG. 5 the pair of female latch members 221 are vertically displaced relative to the pair of male latch members 220 such that the pair of female latch members 221 are positioned above the pair of male latch members 220, and with respect to body 218 on the right end of jumper 105-L in FIG. 5 the pair of female latch members 221 are vertically displaced relative to the pair of male latch members 220 such that the pair of female latch members 221 are positioned below the pair of male latch members 220.

Further, according to an exemplary embodiment of receptacle 104-R (and thus also receptacle 104-L), body 210 includes two halves 436A, 436B (which can also be referred to as a base 436A and a cover 436B), which can be joined together in any suitable manner, such as (for example and not limitation) by way of a snap fit and/or fasteners (such as rivets). Similarly, according to an exemplary embodiment of jumper 105-L (and thus also jumper 105-R), body 218 includes two halves 437A, 437B (which can also be referred to as a base 437A and a cover 437B), which can be joined together in any suitable manner, such as (for example and not limitation) by way of a snap fit and/or fasteners (such as rivets).

According to an embodiment of the present invention, body halves 436A, 436B, 437A, 437B (as well as outlet faces 206 and any other suitable part of electrical distribution system 102) can be made of any suitable material, such as (for example and not by way of limitation) a metal and/or a polymer, and can be formed in any suitable manner, such as (for example and not by way of limitation) a molding operation, such as injection molding. Thus, according to an embodiment of the present invention, latch members 214, 215, 216, 217, 220, 221 can be formed integral—as part of an injection molding operation—with their respective body halves 436A, 436B, 437A, 437B.

Referring now to FIG. 5, there is shown an exploded perspective view of an electrical receptacle, namely, receptacle 104-L. Shown are body halves 436A, 436B, outlet face 206 which attaches to or is formed as a part of body half 436B, shutters 538 which couple with body half 436B, compression springs 539 which couple with body half 436B, and electrical terminals 540, 541, 542, 543 which position within body halves 436A, 436B and are made of any suitable electrically conductive material. Terminal 540 is a neutral terminal, terminal 541 is a ground terminal, terminal 542 is line terminal (pass-through), and terminal 543 is line terminal. Body half 436A is shown to include part of electrical connector 207A including female ports 331-1, 331-2, 331-3, 331-4 and part of electrical connector 207B including male ports 330-1, 330-2, 330-3, 330-4. Similarly, body half 436B is shown to include part of electrical connector 207A including female ports 331-1, 331-2, 331-3, 331-4 and part of electrical connector 207B including male ports 330-1, 330-2, 330-3, 330-4. Terminal 540 includes opposing longitudinal ends that are positioned respectively in male ports 330-1 and female ports 331-1 of housing halves 436A, 436B; more specifically, each opposing longitudinal end of terminal 540 includes a male portion 540-M and a female portion 540-F, the male portion 540-M being positioned in female ports 331-1 of housing halves 436A, 436B, the female portion 540-F being positioned in male ports 330-1 of housing halves 436A, 436B. Terminal 541 includes opposing longitudinal ends that are positioned respectively in male ports 330-2 and female ports 331-2 of housing halves 436A, 436B; more specifically, each opposing longitudinal end of terminal 541 includes a male portion 541-M and a female portion 541-F, the male portion 541-M being positioned in female ports 331-2 of housing halves 436A, 436B, the female portion 541-F being positioned in male ports 331-2 of housing halves 436A, 436B. Terminal 542 includes opposing longitudinal ends that are positioned respectively in male ports 330-3 and female ports 331-3 of housing halves 436A, 436B; more specifically, each opposing longitudinal end of terminal 542 includes a male portion 542-M and a female portion 542-F, the male portion 542-M being positioned in female ports 331-3 of housing halves 436A, 436B, the female portion 542-F being positioned in male ports 330-3 of housing halves 436A, 436B. Terminal 543 includes opposing longitudinal ends that are positioned respectively in male ports 330-4 and female ports 331-4 of housing halves 436A, 436B; more specifically, each opposing longitudinal end of terminal 543 includes a male portion 543-M and a female portion 543-F, the male portion 543-M being positioned in female ports 331-4 of housing halves 436A, 436B, the female portion 543-F being positioned in male ports 330-4 of housing halves 436A, 436B. During connection of electrical connectors 207A, 207B of receptacles 104-L, 104-R, male ports 330 are received by female ports 331, and female portions 540-F, 541-F, 542-F, 543-F of terminals 540, 541, 542, 543 receive male portions 540-M, 541-M, 542-M, 543-M of terminals 540, 541, 542, 543.

Further, each female latch member 215, 217 of receptacle 104-L (and thus also receptacle 104-R) includes an inwardly projecting ramp 544 and a recess 545. Each ramp 544 is configured for being abutted against by a respective distal portion 323, 327 (in particular, a respective barb 325, 329) respectively as male latch members 214, 216, 220 are respectively inserted in female latch portions 215, 217. As this abutment occurs, male latch members 214, 216, 220 (which are resilient) are deflected inwardly as distal portions 323, 327 slide along ramps 544. Each recess 545 is configured for receiving and holding therein a respective barb 325, 329 after a respective distal portion 323, 327 of respective male latch members 214, 216, 220 slide over a respective ramp 536 when respective male latch members 214, 216, 220 are inserted in respective female latch members 215, 217.

Referring now to FIG. 6, there is shown an exploded perspective view of a jumper assembly, namely, jumper assembly 105-L. Shown are conduit 209, opposing longitudinal ends of jumper 105-L with body halves 437A, 437B, conduit clamps 649 for securing longitudinal ends of conduit 209 to body halves 437A, 437B using rivets 648, and electrical terminals 650, 651, 652, 653 which are positioned within body halves 437A, 437B and are made of any suitable electrically conductive material. Terminals 650, 651, 652, 653, according to the illustrated embodiment of the present invention, are substantially identical to one another and can serve as (not necessarily in a particular order) neutral, ground, and two line terminals.

Body half 437A is shown to include part of electrical connector 208A (right end in FIG. 6, which is the left end in FIG. 2) including female ports 333-1, 333-2, 333-3, 333-4, and body half 437B is shown to include part of electrical connector 208A (right end in FIG. 6) including male ports 332-1, 332-2, 332-3, 332-4. Further, body half 437A is shown to include part of electrical connector 208B (left end in FIG. 6) including female ports 333-1, 333-2, 333-3, 333-4, and body half 437B is shown to include part of electrical connector 208B (left end in FIG. 6) including male ports 332-1, 332-2, 332-3, 332-4.

With respect to the right end in FIG. 6 (which is the left end in FIG. 2), terminal 650 is positioned respectively in male port 332-1 and female port 333-1 of housing halves 437A, 437B; more specifically, the male portion of terminal 650 is positioned in female port 333-1 of housing half 437A, and the female portion 650-F is positioned in male port 332-1 of housing half 437B. Terminal 651 is positioned respectively in male port 332-2 and female port 333-2 of housing halves 437A, 437B; more specifically, the male portion of terminal 651 is positioned in female port 333-2 of housing half 437A, and the female portion 651-F is positioned in male port 332-2 of housing half 437B. Terminal 652 is positioned respectively in male port 332-3 and female port 333-3 of housing halves 437A, 437B; more specifically, the male portion of terminal 652 is positioned in female port 333-3 of housing half 437A, and the female portion 652-F is positioned in male port 332-3 of housing half 437B. Terminal 653 is positioned respectively in male port 332-4 and female port 333-4 of housing halves 437A, 437B; more specifically, male portion 653-M of terminal 653 is positioned in female port 333-4 of housing half 437A, and the female portion 653-F is positioned in male port 332-4 of housing half 437B.

With respect to the left end in FIG. 6 (which is the right end in FIG. 2), terminal 650 is positioned respectively in male port 332-1 and female port 333-1 of housing halves 437A, 437B; more specifically, male portion 650-M of terminal 650 is positioned in female port 333-1 of housing half 437A, and the female portion 650-F is positioned in male port 332-1 of housing half 437B. Terminal 651 is positioned respectively in male port 332-2 and female port 333-2 of housing halves 437A, 437B; more specifically, male portion 651-M of terminal 651 is positioned in female port 333-2 of housing half 437A, and the female portion 651-F is positioned in male port 332-2 of housing half 437B. Terminal 652 is positioned respectively in male port 332-3 and female port 333-3 of housing halves 437A, 437B; more specifically, male portion 652-M of terminal 652 is positioned in female port 333-3 of housing half 437A, and the female portion 652-F is positioned in male port 332-3 of housing half 437B. Terminal 653 is positioned respectively in male port 332-4 and female port 333-4 of housing halves 437A, 437B; more specifically, male portion 653-M of terminal 653 is positioned in female port 333-4 of housing half 437A, and the female portion 653-F is positioned in male port 332-4 of housing half 437B. During connection of electrical connectors 208A, 208B of jumpers 105-L with any other electrical module for example, male ports 332 are received by female ports 333, and the female portions of terminals 650, 651, 652, 653 receive the male portions of the terminals of another electrical module.

Further, each female latch member 221 of jumper 105-L (and thus also jumper 105-R) includes an inwardly projecting ramp 646 and a recess 648. Each ramp 646 is configured for being abutted against by a respective distal portion 323, 327 (in particular, a respective barb 325, 329) respectively as male latch members 214, 216, 220 are respectively inserted in female latch members 221. As this abutment occurs, male latch members 214, 216, 220 (which are resilient) are deflected inwardly as distal portions 323, 327 slide along ramps 646. Each recess 648 is configured for receiving and holding therein a respective barb 325, 329 after a respective distal portion 323, 327 of respective male latch members 214, 216, 220 slide over a respective ramp 646 when respective male latch members 214, 216, 220 are inserted in respective female latch members 221.

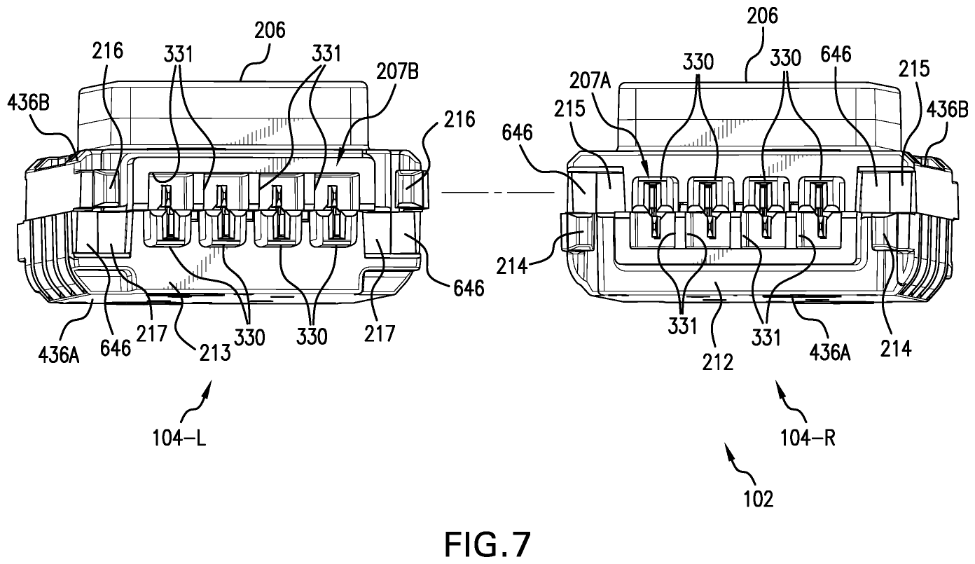

Referring now to FIG. 7, there is shown a perspective view of receptacles 104-L, 104-R, with mating ends of receptacles 104-L, 104-R turned in toward one another. Thus, in the foreground of FIG. 7 are end 213 of receptacle 104-L and end 212 of receptacle 104-R. Shown in FIG. 7 are also male latch members 214, 216, female latch members 215, 217, and male ports 330 and female ports 331 of electrical connectors 207A, 207B. Further, respective barbs 325 seat respectively in respective recesses 545 of female latch members 215, 217. This seating occurs after barbs 325 slide along respective ramps 544 of female latch members 215, 217 (which causes male latch members 214, 216 to deflect inwardly toward one another), male latch members 214, 216 snapping into place in a respective recesses 545 after traversing ramps 544. Male latch members 214, 216 can be released from recesses 545 when a user depresses male latch members 214, 216 inwardly toward one another (such as by way of a thumb and forefinger of user) so as to clear recesses 545, and then user can pull receptacles 104-L and 104-R away from one another to complete the disengagement of receptacles 104-L and 104-R relative to one another. FIG. 7 is illustrative of any connection made between receptacles 104-L, 104-R and jumper 105-L, 105-R.

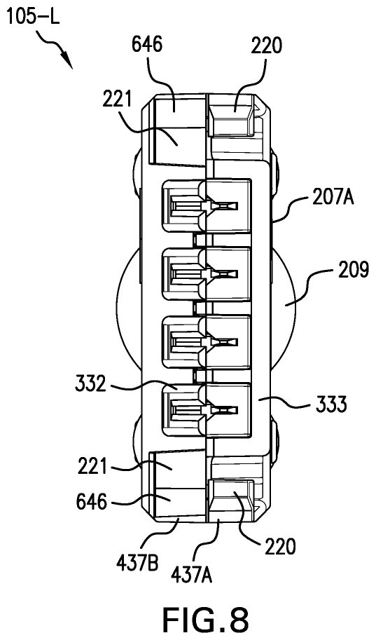

Referring now to FIG. 8, there is shown an end view of the left end (as in FIG. 2) of jumper 105-L (and thus also of jumper 105-R). Shown in FIG. 8 are also male latch members 220, female latch members 221, and male ports 332 and female ports 333 of electrical connectors 208A. The left end of jumper 105-L is substantially similar to the right end of jumper 105-L, except that the right end would be rotated 180 degrees about an axis extending perpendicular to the page of FIG. 8 relative to the left end. Further, respective barbs 329 seat respectively in respective recesses 545, 647 of female latch members 215, 217, 221. This seating occurs after barbs 329 slide along respective ramps 544, 646 of female latch members 215, 217, 221 (which causes male latch members 214, 216, 220 to deflect inwardly toward one another), male latch members 214, 216, 220 snapping into place in a respective recesses 647 after traversing ramps 646. Male latch members 214, 216, 220 can be released from recesses 647 when a user depresses male latch members 214, 216, 221 inwardly toward one another (such as by way of a thumb and forefinger of user) so as to clear recesses 647, and then user can pull respective receptacles 104-L, 104-R and jumpers 105-L, 105-R away from one another to complete the disengagement of respective receptacles 104-L, 104-R and jumpers 105-L, 105-R relative to one another.

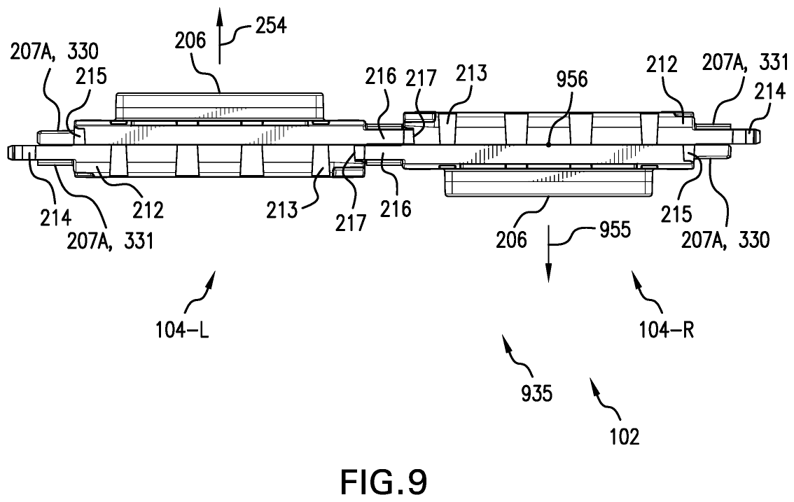

Referring now to FIG. 9, there is shown a side view of electrical distribution system 102 in orientation 935. More specifically, FIG. 9 shows receptacle 104-L and receptacle 104-R connected to one another in orientation 955. In orientation 935, second end 213 of receptacle 104-L and second end 213 of receptacle 104-R are adjacent to one another, and thus electrical connector 207B of second end 213 of receptacle 104-L is connected to electrical connector 207B of second end 213 of receptacle 104-R, male latch member 216 of second end 213 of receptacle 104-L is connected with female latch member 217 of second end 213 of receptacle 104-R, and male latch member 216 of second end 213 of receptacle 104-R is connected with female latch member 217 of second end 213 of receptacle 104-L. Thus, when receptacles 104-L, 104-R are in orientation 935 relative to one another, outlet face 206 of receptacle 104-L faces in first direction 254, and outlet face 206 of receptacle 104-R faces in a second direction 955 which is opposite first direction 254, and electrical connector 207B of receptacle 104-L is connected directly to electrical connector 207B of receptacle 104-R. To move receptacle 104-R from first orientation 234 to second orientation 935, receptacle 109-R is pivoted 180 degrees about an axis 956 extending perpendicular to the page of FIG. 9 and thus substantially perpendicularly through each longitudinal side of receptacle 104-R.

In use, electrical distribution system 102 can be coupled with one or more wall panels 101 to form electrical wall panel system 100. Receptacles 104-L, 104-R and jumpers 105-L, 105-R can be accommodated at least substantially within a thin wall panel 101, such as a one-inch thick wall panel, such that raceway 103 is also one-inch thick. Further, receptacles 104-L, 104-R can be selectively connected to one another in either of first orientation 234 (where outlet faces 206 of receptacles 104-L, 104-R face in the same direction relative to one another) or second orientation 935 (where outlet faces 206 of receptacles 104-L, 104-R face in opposite directions relative to one another). To make these connections, pertinent electrical connectors 207A, 207B, 208A, 208B and male and female latch members 214, 215, 216, 217, 220, 221 are connected to one another. To connect male and female latch members 214, 215, 216, 217, 220, 221 together, pertinent male latch members 214, 216, 220 are squeezed toward one another. To detach receptacles 104-L, 104-R and jumpers 105-L, 105-R from one another, pertinent male latch members 214, 216, 220 are squeezed toward one another to unseat barbs 325, 329 from recesses 545, 647, and then receptacles 104-L, 104-R, jumper 105-L, 105-R are pulled apart from one another.

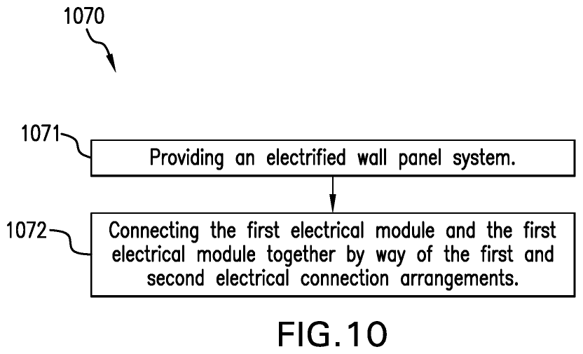

Referring now to FIG. 10, there is shown a flow diagram of a method 1070 of using electrified office furniture system 100. Method 1070 includes the steps of: providing 1071 that electrified office furniture system 100 includes at least one piece of office furniture 1101, 101 and electrical distribution system 102 associated with the at least one piece of office furniture 1101, 101; electrical distribution system 102 including first electrical module 104-L, 104-R, 105-L, 105-R and second electrical module 104-L, 104-R, 105-L, 105-R, first electrical module 104-L, 104-R, 105-L, 105-R being a first electrical receptacle 104-L, 104-R or a first jumper assembly 105-L, 105-R, the first electrical module 104-L, 104-R, 105-L, 105-R including a first electrical connection arrangement 257 that is hermaphroditic, second electrical module 104-L, 104-R, 105-L, 105-R being a second electrical receptacle 104-L, 104-R or a second jumper assembly 105-L, 105-R, the second electrical module 104-L, 104-R, 105-L, 105-R including a second electrical connection arrangement 258 that is hermaphroditic; and connecting 1072, selectively and releasably, first electrical module 104-L, 104-R, 105-L, 105-R and second electrical module 104-L, 104-R, 105-L, 105-R directly to one another by way of first electrical connection arrangement 257 and second electrical connection arrangement 258. Optionally, first electrical module 104-L, 104-R, 105-L, 105-R is the first electrical receptacle 104-L, 104-R, and second electrical module 104-L, 104-R, 105-L, 105-R is the second electrical receptacle 104-L, 104-R. Optionally, first electrical module 104-L, 104-R, 105-L, 105-R is the first electrical receptacle 104-L, 104-R, and second electrical module 104-L, 104-R, 105-L, 105-R is the second jumper assembly 105-L, 105-R. Optionally, first electrical module 104-L, 104-R, 105-L, 105-R is the first jumper assembly 105-L, 105-R, and second electrical module 104-L, 104-R, 105-L, 105-R is the second jumper assembly 105-L, 105-R. Receptacles 104-L and 104-R, receptacle 104-R and jumper 105-L, and jumper 105-L and jumper 105-R respectively are selectively and releasably connected directly to one another by way of electrical connection arrangements 257, 258. Each of electrical connection arrangements 257, 258 includes a first plurality of male ports 330, 332 a first plurality of female ports 331, 333 a first plurality of male terminals 540-M, 541-M, 542-M, 543-M, 650-M, 651-M, 652-M, 653-M and a first plurality of female terminals 540-F, 541-F, 542-F, 543-F, 650-F, 651-F, 652-F, 653-F. The at least one piece of office furniture 1101, 101 includes an elongate distribution arrangement 1103, 103, the electrical distribution system 102 being associated with the elongate distribution arrangement 1103, 103, the first electrical module 104-L, 104-R, 105-L, 105-R and the second electrical module 104-L, 104-R, 105-L, 105-R each being positioned within the elongate distribution arrangement 1103, 103, each said elongate distribution arrangement 1103, 103 including: a beltline raceway 1103 in an office wall panel 1101; a bottom raceway 103 in an office wall panel 101; a distribution channel 1103 formed in a desk 1101 or table 1101; or a distribution channel 1103 attached to the bottom of a desk 1101 or table 1101.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An electrified office furniture system, comprising:
at least one piece of office furniture; and
an electrical distribution system associated with the at least one piece of office furniture, the electrical distribution system including:
a first electrical module which is a first electrical receptacle or a first jumper assembly, the first electrical module including a first electrical connection arrangement that is hermaphroditic; and
a second electrical module which is a second electrical receptacle or a second jumper assembly, the second electrical module including a second electrical connection arrangement that is hermaphroditic, the first electrical module and the second electrical module being selectively and releasably connected directly to one another by way of the first electrical connection arrangement and the second electrical connection arrangement.

2. The electrified office furniture system according to claim 1, wherein the first electrical module is the first electrical receptacle, and the second electrical module is the second electrical receptacle.

3. The electrified office furniture system according to claim 1, wherein the first electrical module is the first electrical receptacle, and the second electrical module is the second jumper assembly.

4. The electrified office furniture system according to claim 1, wherein the first electrical module is the first jumper assembly, and the second electrical module is the second jumper assembly.

5. The electrified office furniture system according to claim 1, wherein each of the first electrical connection arrangement and the second electrical connection arrangement includes a first plurality of male ports, a first plurality of female ports, a first plurality of male terminals, and a first plurality of female terminals.

6. The electrified office furniture system of claim 1, wherein the at least one piece of office furniture includes an elongate distribution arrangement, the electrical distribution system being associated with the elongate distribution arrangement, the first electrical module and the second electrical module each being positioned within the elongate distribution arrangement, each said elongate distribution arrangement comprising one of:
a beltline raceway in an office wall panel;
a bottom raceway in an office wall panel;
a distribution channel formed in a desk or table; and
a distribution channel attached to the bottom of a desk or table.

7. An electrical distribution system for an electrified office furniture system, the electrified office furniture system including at least one piece of office furniture, the electrical distribution system being associated with the at least one piece of office furniture, the electrical distribution system comprising:
a first electrical module, the first electrical module being a first electrical receptacle or a first jumper assembly, the first electrical module including a first electrical connection arrangement that is hermaphroditic, the first electrical module being configured for being selectively and releasably connected directly to a second electrical module-which is a second electrical receptacle or a second jumper assembly and includes a second electrical connection arrangement that is hermaphroditic—by way of the first electrical connection arrangement and the second electrical connection arrangement.

8. The electrical distribution system according to claim 7, wherein the electrical distribution system includes the second electrical module, the second electrical module being the second electrical receptacle or the second jumper assembly, the second electrical module including the second electrical connection arrangement that is hermaphroditic, the first electrical module and the second electrical module being selectively and releasably connected directly to one another by way of the first electrical connection arrangement and the second electrical connection arrangement,
wherein the first electrical module is the first electrical receptacle, and the second electrical module is the second electrical receptacle.

9. The electrical distribution system according to claim 7, wherein the electrical distribution system includes the second electrical module, the second electrical module being the second electrical receptacle or the second jumper assembly, the second electrical module including the second electrical connection arrangement that is hermaphroditic, the first electrical module and the second electrical module being selectively and releasably connected directly to one another by way of the first electrical connection arrangement and the second electrical connection arrangement,
wherein the first electrical module is the first electrical receptacle, and the second electrical module is the second jumper assembly.

10. The electrical distribution system according to claim 7, wherein the electrical distribution system includes the second electrical module, the second electrical module being the second electrical receptacle or the second jumper assembly, the second electrical module including the second electrical connection arrangement that is hermaphroditic, the first electrical module and the second electrical module being selectively and releasably connected directly to one another by way of the first electrical connection arrangement and the second electrical connection arrangement,
wherein the first electrical module is the first jumper assembly, and the second electrical module is the second jumper assembly.

11. The electrical distribution system according to claim 7, wherein the electrical distribution system includes the second electrical module, the second electrical module being the second electrical receptacle or the second jumper assembly, the second electrical module including the second electrical connection arrangement that is hermaphroditic, the first electrical module and the second electrical module being selectively and releasably connected directly to one another by way of the first electrical connection arrangement and the second electrical connection arrangement,
wherein each of the first electrical connection arrangement and the second electrical connection arrangement includes a first plurality of male ports, a first plurality of female ports, a first plurality of male terminals, and a first plurality of female terminals.

12. The electrified office furniture system of claim 7, wherein the electrical distribution system is configured such that the at least one piece of office furniture includes an elongate distribution arrangement, the electrical distribution system being associated with the at least one piece of office furniture, the first electrical module and the second electrical module each being positioned within the elongate distribution arrangement, each said elongate distribution arrangement comprising one of:
a beltline raceway in an office wall panel;
a bottom raceway in an office wall panel;
a distribution channel formed in a desk or table; and
a distribution channel attached to the bottom of a desk or table.

13. A method of using an electrified office furniture system, the method comprising the steps of:
providing that the electrified office furniture system includes at least one piece of office furniture and an electrical distribution system associated with the at least one piece of office furniture, the electrical distribution system including a first electrical module and a second electrical module, the first electrical module being a first electrical receptacle or a first jumper assembly and including a first electrical connection arrangement that is hermaphroditic, the second electrical module being a second electrical receptacle or a second jumper assembly and including a second electrical connection arrangement that is hermaphroditic; and
connecting, selectively and releasably, the first electrical module and the second electrical module directly to one another by way of the first electrical connection arrangement and the second electrical connection arrangement.

14. The method according to claim 13, wherein the first electrical module is the first electrical receptacle, and the second electrical module is the second electrical receptacle.

15. The method according to claim 13, wherein the first electrical module is the first electrical receptacle, and the second electrical module is the second jumper assembly.

16. The method according to claim 13, wherein the first electrical module is the first jumper assembly, and the second electrical module is the second jumper assembly.

17. The method according to claim 13, wherein each of the first electrical connection arrangement and the second electrical connection arrangement includes a first plurality of male ports, a first plurality of female ports, a first plurality of male terminals, and a first plurality of female terminals.

18. The method according to claim 13, wherein the at least one piece of office furniture includes an elongate distribution arrangement, the electrical distribution system being associated with the elongate distribution arrangement, the first electrical module and the second electrical module each being positioned within the elongate distribution arrangement, each said elongate distribution arrangement comprising one of:
a beltline raceway in an office wall panel;
a bottom raceway in an office wall panel;
a distribution channel formed in a desk or table; and
a distribution channel attached to the bottom of a desk or table.
